(19) United States
(12) Patent Application Publication
(10) Pub. No.: US 2023/0194045 A1
(43) Pub. Date: Jun. 22, 2023

(54) CONNECTOR FOR CONNECTING REFLECTOR PANEL TO BRACKET

(71) Applicant: CommScope Technologies LLC, Hickory, NC (US)

(72) Inventor: Muhammed Ameer P, Kerala (IN)

(21) Appl. No.: 18/056,895

(22) Filed: Nov. 18, 2022

Related U.S. Application Data
(60) Provisional application No. 63/290,926, filed on Dec. 17, 2021.

(51) Int. Cl. F16M 13/02; F16M 11/04

(52) U.S. Cl. CPC F16M 13/02; F16M 11/04

(57) ABSTRACT

A connector for connecting a reflector panel to a bracket includes a gripping element extending from an upper surface of a base plate of the connector. The gripping element is configured to provide isolation between the reflector panel and the bracket. The gripping element has a threaded hole adapted to receive a fastener for connecting the reflector panel with the bracket through the connector. The connector further includes an at least one locking element to facilitate locking of the connector with the reflector panel. The connector provides isolation between the reflector panel & the bracket and at the same time absorbs torque exerted on the connector during tightening of the fastener.

### RELATED APPLICATION

The present application claims priority from and the benefit of U.S. Provisional Pat. Application No. 63/290,926, filed Dec. 17, 2021, the disclosure of which is hereby incorporated herein by reference in full.

### FIELD OF THE INVENTION

The present disclosure relates to communication systems and, in particular, to a connector for connecting a reflector panel to a bracket in a base station antenna.

### BACKGROUND OF THE INVENTION

The information in this section merely provides background information related to the present disclosure and may not constitute prior art(s) for the present disclosure.

Cellular communications systems are used to provide wireless communications to fixed and mobile subscribers (herein “users”). A cellular communications system may include a plurality of base stations that each provide wireless cellular service for a specified coverage area that is typically referred to as a “cell”. Each base station may include one or more base station antennas that are used to transmit radio frequency (“RF”) signals to, and receive RF signals from, the users that are within the cell served by the base station. Base station antennas are directional devices that can concentrate the RF energy that is transmitted in certain directions (or received from those directions). A cellular base station antenna is one of the important factors for an efficient cellular network, and it all depends on choosing the antenna with requisite physical characteristics for a specific application.

Most base station antennas comprise one or more linear or planar arrays of radiating elements that are mounted on a flat panel reflector assembly. Further, the base station antennas comprise one or more reflector panels and the reflector panel is amongst main structural components of the antenna, on to which other elements of the antenna are assembled. The reflector assembly or the reflector may serve as a ground plane for disposing the radiating elements thereon and may also reflect RF energy that is emitted rearwardly by the radiating elements back in the forward direction. The reflectors are mounted on the base station antennas by an intermediate structure, generally defined as brackets that are typically formed of metal. The brackets act as mounting elements for connecting and holding the reflectors in a pre-defined orientation. The RF energy emitted by the reflectors may vary due to the presence of multiple metallic elements mounted on the periphery of the reflectors. The variation in transmission of RF energy may sometimes result in transmission of weak signals to the cells. Some of the brackets are required to be isolated from the reflector electrically in order to reduce or eliminate metal to metal joints and thereby reduce non-linearities and Passive Inter Modulations (PIM).

Manufacturers have sought, proposed, and implemented different solutions to address the above disclosed problem. One of the existing solutions include utilization of a connector as an intermediate member between the bracket and the reflector. Said connector is generally formed of a material that acts as an isolator between the reflector and the bracket, thereby preventing variation in transmission of RF energy to the surroundings and reduce non-linearities as well as Passive Inter Modulations. The connectors generally have a two/multi-part design and are composed of pieces that matingly couple with each other to assemble the reflector and the bracket. However, the two/multi-piece connectors increase the overall cost including manufacturing cost, assembling cost and at the same time maintenance cost. Also, the utilization of said connectors result in increased inventory and assembling of the connector between the reflector and the bracket is complex.

Accordingly, there remains a need of economic yet sustainable connector for connecting the reflector to the bracket.

### SUMMARY OF THE INVENTION

The one or more shortcomings of the prior art are overcome by the connector as claimed, and additional advantages are provided through the provision of the connector as claimed in the present disclosure. Additional features and advantages are realized through the techniques of the present disclosure. Other embodiments and aspects of the disclosure are described in detail herein and are considered a part of the claimed disclosure.

Pursuant to the embodiments of the present disclosure, in an aspect, a connector for connecting a reflector panel to a bracket is provided. The connector comprises a gripping element extending from an upper surface of a base plate of the connector. The gripping element is configured to provide isolation between the reflector panel and the bracket. The gripping element has a threaded hole adapted to receive a fastener for connecting the reflector panel with the bracket through the connector and at least one locking element to facilitate locking of the connector with the reflector panel.

In another non-limiting embodiment of the present disclosure, the gripping element and the at least one locking element are integrally formed on the base plate of the connector.

In another non-limiting embodiment of the present disclosure, the upper surface of the base plate abuts against the reflector panel.

In another non-limiting embodiment of the present disclosure, a connector for connecting a reflector panel to a bracket is provided. The connector comprises a base plate having an upper surface. The connector further comprises a gripping element extending from the upper surface of the base plate. The gripping element is having a threaded hole. The connector comprises an at least one guide pin extending from the upper surface of the base plate and at least two locking elements extending from the upper surface of the base plate to facilitate locking of the connector with the reflector panel.

In another non-limiting embodiment of the present disclosure, the gripping element is defined having a cuboidal shaped structure, configured to provide isolation between the reflector panel and the bracket.

In another non-limiting embodiment of the present disclosure, the at least one guide pin is adapted to be inserted in an at least one hole formed in the reflector panel and in an at least one aperture formed in the bracket.

In another non-limiting embodiment of the present disclosure, the gripping element is adapted to be inserted in a cutout formed in the reflector panel.

In another non-limiting embodiment of the present disclosure, the at least two locking elements are snap-fit elements adapted to be received in at least two slots formed in the reflector panel.

In another non-limiting embodiment of the present disclosure, the gripping element, the at least one guide pin and the at least two locking elements are integrally formed on the base plate of the connector.

In another non-limiting embodiment of the present disclosure, a connector for connecting a reflector panel to a bracket is disclosed. The connector comprises a gripping element formed with a base plate of the connector. The gripping element comprises a threaded hole adapted to receive a fastener for connecting the reflector panel with the bracket through the connector. At least two arms laterally extending from an outer surface of the gripping element, and said at least two arms are configured to provide isolation between the reflector panel and the bracket. A locking element provided on a bottom surface of a first arm of the at least two arms, such that the locking element is configured to lock the connector with the reflector panel. A second arm positioned opposite to the first arm comprising an extended portion formed at junction of the second arm and the gripping element.

In another non-limiting embodiment of the present disclosure, the gripping element is defined having a cylindrical shaped structure with the at least two arms laterally extending from the outer surface of the gripping element.

In another non-limiting embodiment of the present disclosure, the at least two arms are adapted to be received in respective cutouts formed on the reflector panel.

In another non-limiting embodiment of the present disclosure, the locking element is adapted to be received in a slot formed on the reflector panel.

In another non-limiting embodiment of the present disclosure, a length of the respective arm of the at least two arms formed on the gripping element are distinct from one another.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 is a perspective view of a connector for connecting a reflector panel to a bracket, in accordance with an embodiment of the present disclosure;

FIG. 2 is a bottom perspective view of the connector of FIG. 1, in accordance with an embodiment of the present disclosure;

FIG. 3 is a top view of the connector of FIG. 1, in accordance with an embodiment of the present disclosure;

FIG. 4 is a side view of the connector of FIG. 1, in accordance with an embodiment of the present disclosure;

FIG. 5 is an enlarged top view of a reflector panel, in accordance with an embodiment of the present disclosure;

FIG. 6 is a perspective of a reflector panel connected to a bracket using the connector of FIG. 1, in accordance with an embodiment of the present disclosure;

FIG. 7 is a bottom view of the reflector assembly of FIG. 6, in accordance with an embodiment of the present disclosure;

FIG. 8 is a top view of the reflector assembly of FIG. 6, in accordance with an embodiment of the present disclosure;

FIG. 9 is a cross-sectional view of the reflector assembly of FIG. 8, taken along the line A-A, in accordance with an embodiment of the present disclosure;

FIG. 10 is a perspective view of the connector for connecting the reflector panel to the bracket, in accordance with another embodiment of the present disclosure;

FIG. 11 is a bottom perspective view of the connector of FIG. 10, in accordance with an embodiment of the present disclosure;

FIG. 12 is a top view of the connector of FIG. 10, in accordance with an embodiment of the present disclosure;

FIG. 13 is a side view of the connector of FIG. 10, in accordance with an embodiment of the present disclosure;

FIG. 14 is an enlarged top view of a reflector panel, in accordance with an embodiment of the present disclosure;

FIG. 14A is an enlarged top view of the reflector panel of FIG. 14 with the connector of FIG. 10, in accordance with an embodiment of the present disclosure;

FIG. 14B is an enlarged top view of the reflector panel of FIG. 14 with the connector of FIG. 10 in locked position, in accordance with an embodiment of the present disclosure;

FIG. 15 is a perspective of a reflector panel connected to a bracket through the connector of FIG. 10, in accordance with an embodiment of the present disclosure;

FIG. 16 is a top view of the reflector assembly of FIG. 15, in accordance with an embodiment of the present disclosure;

FIG. 17 is a cross-sectional view of the reflector assembly of FIG. 16, taken along the line B-B, in accordance with an embodiment of the present disclosure;

FIG. 18 is a bottom view of the reflector assembly of FIG. 15, in accordance with an embodiment of the present disclosure;

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION OF THE INVENTION

While the disclosure is susceptible to various modifications and alternative forms, specific embodiments thereof have been shown by way of example in the FIGS. and will be described in detail below. It should be understood, however that it is not intended to limit the disclosure to the particular forms disclosed, but on the contrary, the disclosure is to cover all modifications, equivalents, and alternatives falling within the scope of the disclosure as defined by the appended claims.

Before describing detailed embodiments, it may be observed that the novelty and inventive step that are in accordance with the present disclosure resides in a connector for connecting a reflector panel to a bracket in a base station antenna. It is to be noted that a person skilled in the art can be motivated from the present disclosure and modify the various constructions of the connector of reflector panel. However, such modification should be construed within the scope of the present disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusions, such that a device that comprises a list of components does not include only those components but may include other components not expressly listed or inherent to such device. In other words, one or more elements in a system or apparatus proceeded by “comprises... a” does not, without more constraints, preclude the existence of other elements or additional elements in the system or apparatus.

The terms like “at least one” and “one or more” may be used interchangeably or in combination throughout the description.

The connector is defined as an intermediate element for connecting a reflector panel to a bracket in a base station antenna. The reflector panel is defined to be a main structural component of the base station antenna and the reflector panel is configured to provide provisions for mounting an array of radiating elements. The reflector panel is mounted to the base station antenna through a plurality of brackets. Some of these brackets are required to be isolated from the reflector panel electrically, in order to reduce, eliminate or isolate metal to metal joints and thereby reducing non-linearities and Passive Inter Modulation (PIM). The connector is configured to electrically isolate the reflector panel from the bracket. The connector may also be referred as a “spacer” positioned between the reflector panel and the bracket. The connector comprises a gripping element, which is configured to isolate the reflector panel from the bracket. The connector may be utilized to isolate metal to metal joints between other respective components of the reflector panel. The gripping element is also configured to absorb torque acting on the connector during mounting of the bracket onto the reflector panel. The connector disclosed in the present application is defined having a unitary structure, positioned between the reflector panel and the bracket.

The bracket is configured to mount the reflector panel to the base station antenna, at a pre-defined inclination. The number of brackets required to mount the reflector panel onto the base station antenna is based on the physical characteristics of the reflector panel, for example – length, width, size of the reflector panel and the like characteristics of the reflector panel. The base station antenna provides provision for mounting of one or more reflector panels.

The connector described in the present disclosure is configured to connect a reflector panel to a bracket in a base station antenna (hereinafter referred to as “antenna”); when compared to the existing systems, the connector reduces the inventory as the connector is formed as a single unit (i.e., unitary) structure, thereby reducing the number of components that the installer would need during assembly of the reflector panel with the bracket, and thus, reducing an overall cost of the antenna. Furthermore, according to one embodiment of the present disclosure, the single unit structure of the connector or unitary formed connector is manufactured from molding processes, for example: injection molding process and the likewise. However, different forming processes may be utilized to form the unitary structure of the connector, in accordance with the present disclosure.

Pursuant to embodiments of the present disclosure, a connector for connecting a reflector panel to a bracket is provided. The connector comprises a gripping element extending from an upper surface of a base plate of the connector. The gripping element is configured to provide isolation between the reflector panel and the bracket. The gripping element has a threaded hole adapted to receive a fastener for connecting the reflector panel with the bracket through the connector and at least one locking element to facilitate locking of the connector with the reflector panel.

In an embodiment, the gripping element and the at least one locking element are integrally formed on the base plate of the connector.

In accordance with further embodiments, the upper surface of the base plate abuts against the reflector panel.

In another non-limiting embodiment of the present disclosure, a connector for connecting a reflector panel to a bracket is provided. The connector comprises a base plate having an upper surface. The connector further comprises a gripping element extending from the upper surface of the base plate. The gripping element is having a threaded hole, an at least one guide pin extending from the upper surface of the base plate and at least two locking elements extending from the upper surface of the base plate to facilitate locking of the connector with the reflector panel.

Further, in an embodiment, the gripping element is defined having a cuboidal shaped structure, configured to provide isolation between the reflector panel and the bracket.

Furthermore, in an embodiment, the at least one guide pin is adapted to be inserted in an at least one hole formed in the reflector panel and in an at least one aperture formed in the bracket.

In an embodiment, the gripping element is adapted to be inserted in a cutout formed in the reflector panel.

In an embodiment, the at least two locking elements are snap-fit elements adapted to be received in at least two slots formed in the reflector panel.

In an embodiment, the gripping element, the at least one guide pin and the at least two locking elements are integrally formed on the base plate of the connector.

In another non-limiting embodiment of the present disclosure, a connector for connecting a reflector panel to a bracket is disclosed. The connector comprises a gripping element formed with a base plate of the connector. The gripping element comprises a threaded hole adapted to receive a fastener for connecting the reflector panel with the bracket through the connector. At least two arms laterally extending from an outer surface of the gripping element, and said at least two arms are configured to provide isolation between the reflector panel and the bracket. A locking element provided on a bottom surface of a first arm of the at least two arms, such that the locking element is configured to lock the connector with the reflector panel. A second arm positioned opposite to the first arm comprising an extended portion formed at junction of the second arm and the gripping element.

In an embodiment, the gripping element is defined having a cylindrical shaped structure with the at least two arms laterally extending from the outer surface of the gripping element.

In an embodiment, the at least two arms are adapted to be received in respective cutouts formed on the reflector panel.

In an embodiment, the locking element is adapted to be received in a slot formed on the reflector panel.

In an embodiment, a length of the respective arm of the at least two arms formed on the gripping element are distinct from one another.

Reference will now be made to the exemplary embodiments of the disclosure, as illustrated in the accompanying drawings. Wherever possible same numerals will be used to refer to the same or like parts.

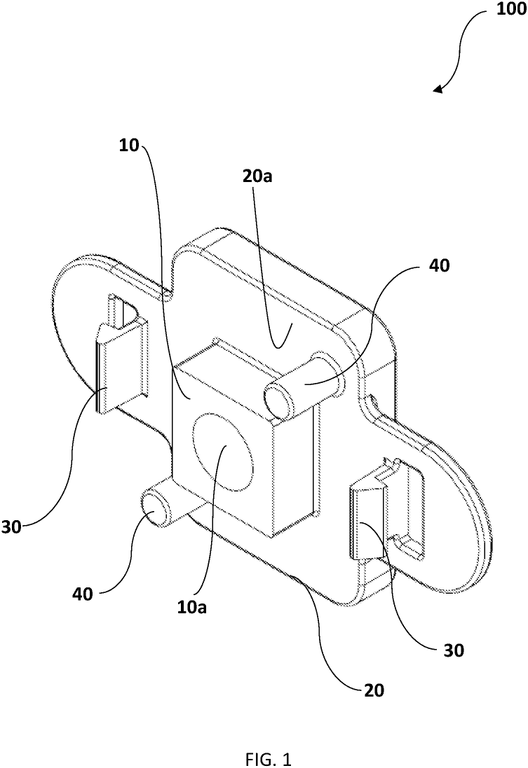

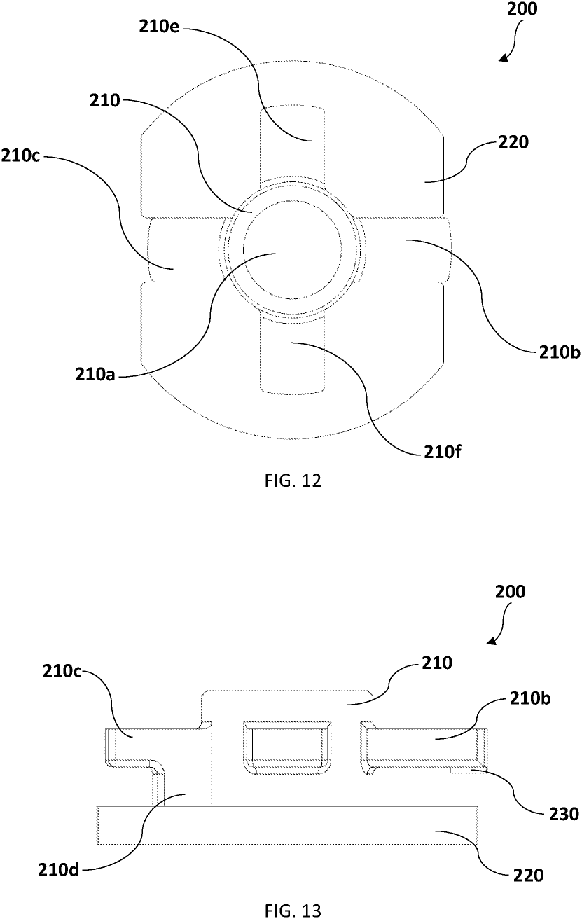

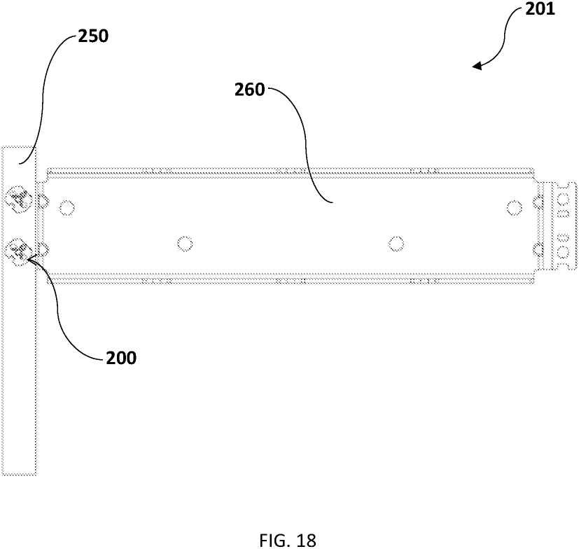

Embodiments of the disclosure are described in the following paragraphs with reference to FIGS. 1 to 17. In FIGS. 1 to 18, the same element or elements which have same functions are indicated by the same reference signs.

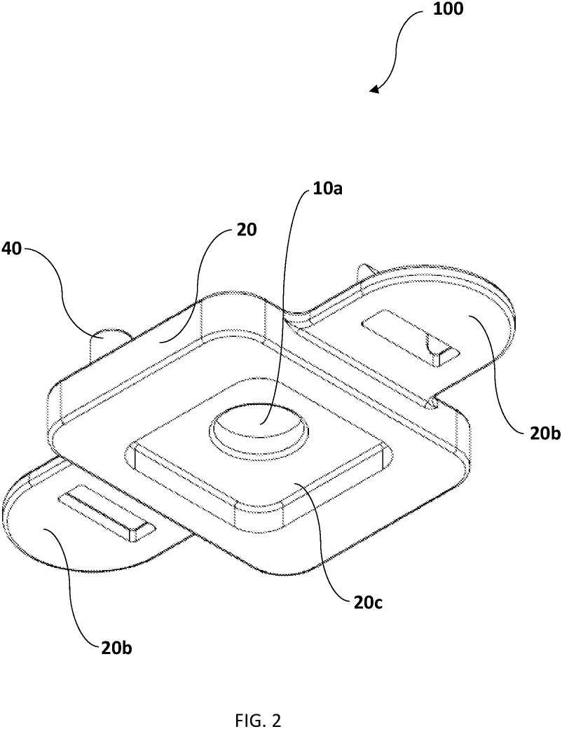

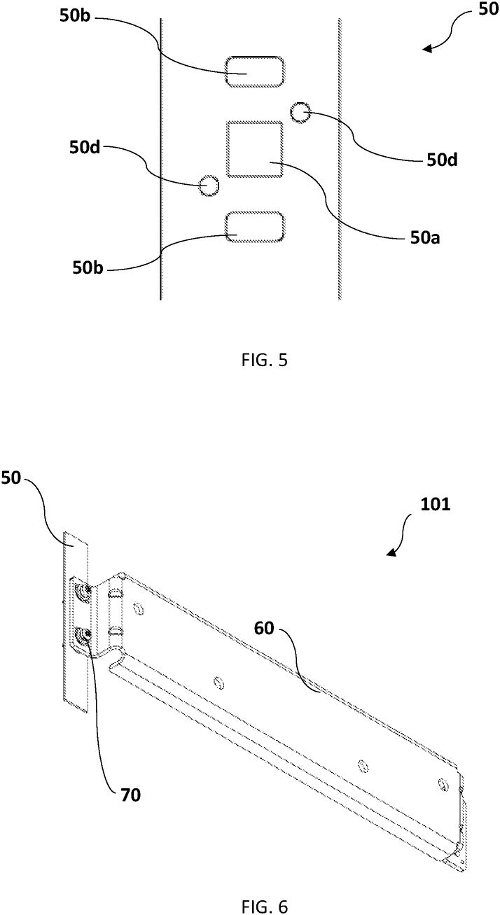

FIG. 1 and FIG. 2 show different perspective views of a connector (100), in accordance with an embodiment of the present disclosure. The connector (100) comprises a gripping element (10), a base plate (20) and at least one locking element (30). The gripping element (10) extends from an upper surface (20a) of the base plate (20) of the connector (100). The gripping element (10) is configured to provide isolation between a reflector panel (50) and a bracket (60), as shown in FIGS. 6 to 9. The gripping element (10) and the at least one locking element (30) are integrally formed on the base plate (20) of the connector (100). The gripping element (10) and the at least one locking element (30) may be formed through any molding processes, for example- injection molding, die molding, and likewise. The gripping element (10) and the at least one locking element (30) may be attached to the base plate (20) through any conventional fixing means, for example - using adhesive, or through thermal processes but not limited to the same.

The gripping element (10) is configured to provide a surface, preferably defined as a top surface for resting the bracket (60) onto the gripping element (10) of the connector (100). In an exemplary embodiment, the gripping element (10) has a threaded hole (10a) adapted to receive a fastener (70) for connecting the reflector panel (50) with the bracket (60) through the connector (100). The gripping element (10) may also be defined having a hole to receive a bolt for connecting the reflector panel (50) to the bracket (60). The gripping element (10) is configured to absorb torque during mounting of the bracket (60) onto the reflector panel (50). The torque is exerted on the connector (100) when a rotational movement is applied to the fastener (70), during tightening of the fastener (70), in order to connect the bracket (60) with the reflector panel (50).

The connector (100) is initially locked to the reflector panel (50) by means of at least one locking element (30). With reference to FIG. 5, the reflector panel (50) comprises a first cutout (50a), at least one slot (50b) and at least one through hole (50d), to facilitate connecting and locking of the connector (100) with the reflector panel (50). The at least one locking element (30) is adapted to be received in the slot (50b) formed on the reflector panel (50) and the gripping element (10) is adapted to be received in the first cutout (50a) formed on the reflector panel (50). The connector (100) is attached or locked to the reflector panel (50), such that the upper surface (20a) of the base plate (20) of the connector (100) abuts against the reflector panel (50). Once the connector (100) is locked to the reflector panel (50), the bracket (60) is placed on the top surface of the gripping element (10). The bracket (60) has a hole (60a) which is aligned with the threaded hole (10a) formed in the gripping element (10) of the connector (100). The fastener (70) is initially allowed to pass through the hole (60a) and then through the threaded hole (10a) of the connector (100), to facilitate connecting the bracket (60) to the reflector panel (50) through the connector (100).

With reference to FIGS. 1-4, the connector (100) in accordance with an embodiment of the present disclosure is depicted. The gripping element (10) has the threaded hole (10a) to receive the fastener (70) for connecting the reflector panel (50) to the bracket (60). The gripping element (10) may be formed having any shape, such that the gripping element (10) provides isolation between the reflector panel (50) and the bracket (60). In an exemplary embodiment, the gripping element (10) is defined having a cuboidal-shaped structure, configured to provide isolation between the reflector panel (50) and the bracket (60). The base plate (20) further comprises a seat (20c) formed on a lower surface of the base plate (20), as shown in FIG. 2. The lower surface of the base plate (20) is defined as a surface opposite to the upper surface (20a). The seat (20c) is formed to provide an area for receiving the nut fastened to the bolt of the fastener (70).

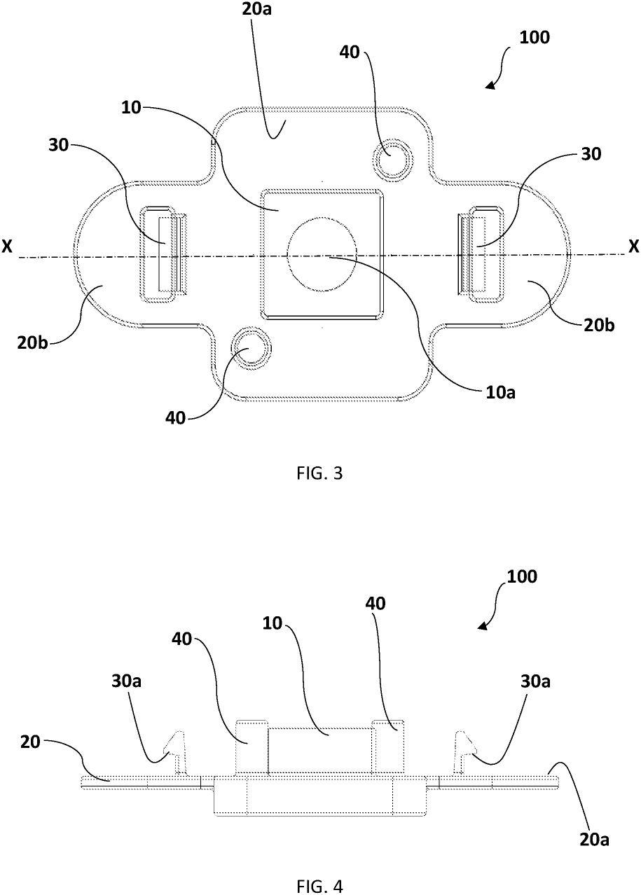

The base plate (20) comprises at least two flanges (20b), extending from opposite edges of the base plate (20) along a longitudinal axis X-X, as shown in FIG. 3. The longitudinal axis X-X is defined as an axis passing through a centre of the threaded hole (10a) of the gripping element (10). The at least two flanges (20b) may be joined to the base plate (20) by conventional joining means, for example – using adhesive, thermal joining methods. or likewise, but typically are integrally formed with the base plate (20), providing a unitary structure. The at least two locking elements (30) are provided on the at least two flanges (20b) of the base plate (20), as shown in FIGS. 2-4. Each of the at least two locking elements (30) are defined having a lip portion (30a), as shown in FIG. 4. The lip portion (30a) is configured to facilitate locking of the connector (100) with the reflector panel (50) by a snap-fit mechanism. The lip portion (30a) abuts against a surface of the reflector panel (50) and prevents dislocation of the connector (100) during tightening or loosening of the fastener (70). The two locking elements (30) comprising the lip portions (30a) are defined having a snap-feature to lock the connector (100) to the reflector panel (50).

The connector (100) further comprises at least one guide pin (40) extending from the upper surface (20a) of the base plate (20). The at least one guide pin (40) is adapted to be inserted in the at least one through hole (50d) formed in the reflector panel (50) and in at least one aperture (60b) formed in the bracket (60). The at least one guide pin (40) may be fixed to the base plate (20) by any fixing means, for example –adhesive, thermal processes or likewise - but typically the guide pins (40) are integrally formed with the remainder of the connector (100) during molding. In an exemplary embodiment, the connector (100) comprises two guide pins (40), as shown in FIGS. 1-4, extending from the upper surface (20a) of the base plate (20). The two guide pins (40) are provided for guiding the connector (100) towards the reflector panel (50). The two guide pins (40) may also be defined as aligning pins of the connector (100). The two guide pins (40) are first received in the two through holes (50d) formed in the reflector panel (50) and then partially received in the two apertures (60b) formed in the bracket (60), while connecting the reflector panel (50) to the bracket (60). The two guide pins (40) are positioned in a diagonally opposite manner (relative to the gripping portion 10) with respect to one another. The two guide pins (40) are integrally formed with the base plate (20) of the connector (100), thereby forming a unitary structure. In an exemplary embodiment, the gripping element (10), the two locking elements (30) and the two guide pins (40) are integrally formed on the upper surface (20a) of the base plate (20) of the connector (100), thereby forming a unitary structure.

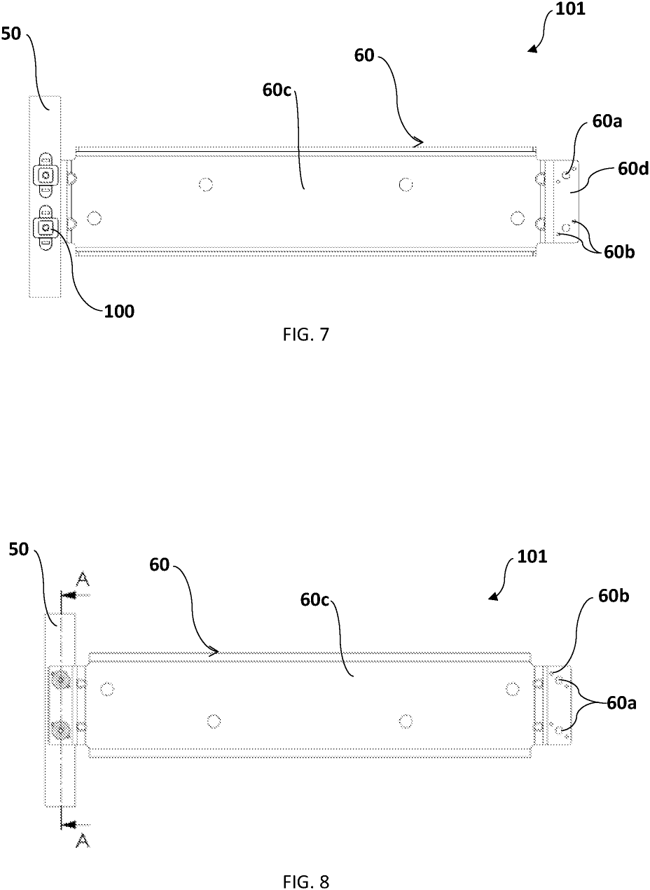

FIGS. 6-9 depict multiple views of a reflector assembly (101), in accordance with an embodiment of the present disclosure. The reflector assembly (101) is defined as an assembly in which the reflector panel (50) is connected to the bracket (60) through the connector (100). The connector (100) employed to connect the reflector panel (50) to the bracket (60) is the connector as shown in FIGS. 1-4. The reflector assembly (101) comprises the reflector panel (50), the bracket (60) and the connector (100) positioned between the reflector panel (50) and the bracket (60). The reflector panel (50) is connected to the bracket (60) by means of the fasteners (70), as shown in FIG. 6. The fastener (70) comprises a screw with a metal or polyester washer (80) for connecting the reflector panel (50) with the bracket (60), in accordance with an exemplary embodiment of the present disclosure. The bracket (60) comprises a panel (60c) having two legs (60d) longitudinally extending from the panel (60c), as shown in FIG. 7. Each of the two legs (60d) has the hole (60a) for receiving the fastener (70) and the apertures (60b) for partially receiving the guide pins (40), as shown in FIG. 8.

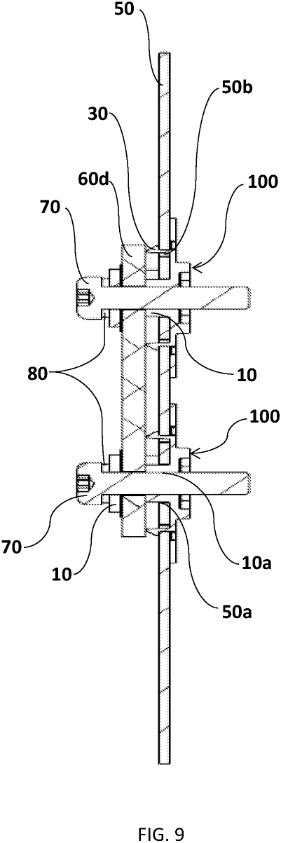

Referring to FIG. 9, a cross-sectional view along line A-A of the reflector assembly (101) is depicted and illustrates a method for connecting the reflector panel (50) to the bracket (60) through the connector (100). The method comprises a first step of locking the connector (100) to the reflector panel (50). Said step comprises aligning the connector (100) such that the guide pins (40) are aligned along the respective through holes (50d) formed in the reflector panel (50), and then pressing the connector (100) towards surface of the reflector panel (50). The pressing of the connector (100) facilitates insertion of the gripping element (10) in the first cutout (50a) formed in the reflector panel (50), simultaneously the locking elements (30) and the guide pins (40) are received in the respective slots (50b) and through holes (50d) in the reflector panel (50). Once the connector (100) is locked to the reflector panel (50) by means of the locking elements (30), the bracket (60) comprising the leg (60d) is placed on the top surface of the gripping element (10) such that the hole (60a) on the leg (60d) of the bracket (60) is aligned with the threaded hole (10a) formed on the gripping element (10) of the connector (100). The method further comprises the step of pressing the bracket (60) towards the gripping element (10), such that the guide pins (40) are partially received inside apertures (60b) formed on the leg (60d) of the bracket (60). The method further comprises the step of allowing a fastener (70) to pass through the hole (60a) and then through the threaded hole (10a) of the gripping element (10), connecting the bracket (60) to the reflector panel (50). The method further comprises the step of rotating the fastener (70) such that the fastener (70) tightly holds the bracket (60) with the reflector panel (50) through the connector (100). The gripping element (10) and the guide pins (40) are configured to absorb torque exerted on the connector (100) during tightening of the fastener (70).

The connector (100) is configured to electrically isolate metal to metal joints between different component of the reflector panel (50). In an exemplary embodiment of the present disclosure, the connector (100) electrically isolates metal to metal joints between the reflector panel (50) and the bracket (60). According to an exemplary embodiment of the present disclosure, the connector (100) is defined having a unitary structure, thus reducing the inventory required during mounting of the bracket (60) to the reflector panel (50). The connector (100) comprising the gripping element (10) and the guide pins (40) are configured to absorb torque exerted on the connector (100) during tightening of the fastener (70). In an exemplary embodiment, in an assembled condition of the reflector assembly (101), a clearance is provided between the bracket (60) and the locking elements (30) to prevent touching of the locking elements (30) with the bracket (60). A length of each of the locking elements (30) is less than a length of the gripping element (10) extending from the upper surface (20a) of the base plate (20) of the connector (100).

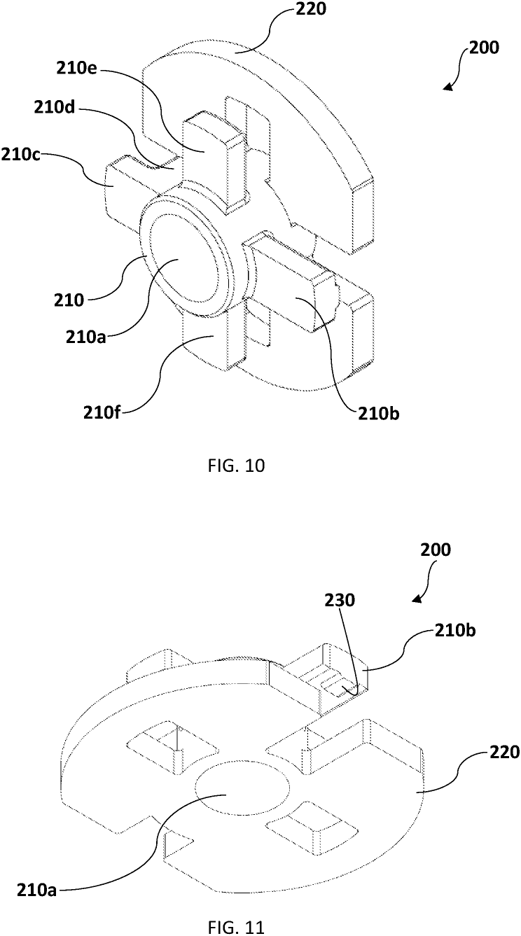

In another exemplary embodiment of the present disclosure, a connector (200) for connecting a reflector panel (250) to a bracket (260), is depicted in FIGS. 10-13. The connector (200) is configured to electrically isolate metal to metal joints formed between components of the reflector panel (250). In an exemplary embodiment, the connector (200) electrically isolates metal to metal joints between the reflector panel (250) and the bracket (260). The connector (200) comprises a gripping element (210) formed with a base plate (220) of the connector (200). The gripping element (210) comprises a threaded hole (210a) adapted to receive a fastener (270) for connecting the reflector panel (250) to the bracket (260) through the connector (200). The fastener (270) comprises a screw with a metal or polyester washer (280) for connecting the reflector panel (250) with the bracket (260), in accordance with an exemplary embodiment of the present disclosure. At least two arms (210b, 210c) extend laterally from an outer surface of the gripping element (210) and said at least two arms (210b, 210c) are configured to provide isolation between the reflector panel (250) and the bracket (260). The gripping element (210) is defined having a cylindrical-shaped structure comprising at least two arms (210b, 210c) laterally extending from the outer surface of the gripping element (210). The gripping element (210) may be defined having any other shaped structure comprising two or more arms (210b, 210c).

A first arm (210b) of the at least two arms (210b, 210c) comprises a locking element (230) for locking the connector (200) with the reflector panel (250). A second arm (210c) of the at least two arms (210b, 210c) is positioned opposite to the first arm (210b). The second arm (210c) comprises an extended portion (210d), as shown in FIG. 13, formed at junction of the second arm (210c) and the gripping element (210). The extended portion (210d) is configured for absorbing torque exerted on the connector (200) during tightening of the fastener (270). The extended portion (210d) extends from a bottom surface of the second arm (210c) coinciding with the outer surface of the gripping element (210).

The connector (200) further comprises the locking element (230) provided on a bottom surface of the first arm (210b) of the at least two arms (210b, 210c), as shown in FIG. 11 and FIG. 13. The locking element (230) is configured to lock the connector (200) with the reflector panel (250). The locking element (230) is defined as a portion protruding from the bottom surface of the first arm (210b). The locking element (230) is configured to be received in a slot (250b) formed in the reflector panel (250) to lock the connector (200) with the reflector.

In an exemplary embodiment of the present disclosure, the gripping element (210) is defined having four arms (210b, 210c, 210e, 210f) positioned equidistant from each other, as shown in FIG. 10 to FIG. 13. The four arms extending from the gripping element (210) are defined as the first arm (210b), the second arm (210c), a third arm (210e) and a fourth arm (210f). The four arms (210b, 210c, 210e, 210f) provide stability and isolation to the bracket (260) when mounted on to the reflector panel (250). In the illustrated embodiment, the first arm (210b) has a greater length than that the arms (210c, 210e, 210f). The locking element (230) is provided on the first arm (210b) of the four arms (210b, 210c, 210e, 210f) and the extended portion (210d) is provided on the second arm (210c) of the four arms (210b, 210c, 210e, 210f).

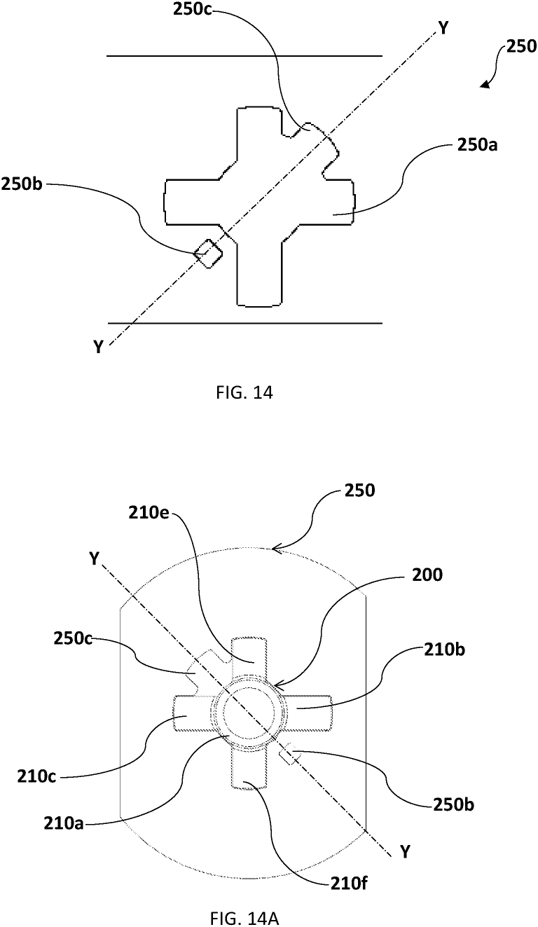

Referring to FIG. 14, an enlarged top view of the reflector panel (250) is depicted. The reflector panel (250) is defined having a first cutout (250a) and the slot (250b). The first cutout (250a) is defined having a profile complimentary to the gripping element (210) with the four arms (210b, 210c, 210e, 210f), such that the first cutout (250a) is configured to receive the gripping element (210) with the four arms (210b, 210c, 210e, 210f) of the connector (200) and allow the gripping element (210) with the four arms (210b, 210c, 210e, 210f) to pass there-through. The reflector panel (250) further defines a second cutout (250c) extending radially from a center portion of the first cutout (250a), such that when the gripping element (210) is passed through the first cutout (250a), the second cutout (250c) lies adjacent the second arm (210c). The second cutout (250c) has a smaller length when compared to the lengths of the remaining cutouts and is formed at an offset from the centre of the first cutout (250a). The slot (250b) is provided diagonally opposite to the second cutout (250c), according to an exemplary embodiment of the present disclosure.

According to an embodiment of the present disclosure and referring to FIG. 14A and FIG. 14B, a method for locking the connector (200) to the reflector panel (250) is disclosed and depicted. The method comprises the steps of placing the connector (200) on the reflector panel (250) such that the gripping element (210) along with its arms (210b, 210c, 210e, 210f) are received in the first cutout (250a) formed in the reflector panel (250), as shown in FIG. 14A. The method further comprises a step of rotating the connector (200) is a clockwise direction such that the first arm (210b) and the second arm (210c) are aligned along the mounting axis Y-Y of the reflector panel (250). The mounting axis Y-Y in defined as an axis passing through the slot (250b) and the second cutout (250c) in the reflector panel (250), as shown in FIG. 14 and FIG. 14A. In this step, a push force F is exerted on the connector (200), such that the locking element (230) provided on the first arm (210b) is received in the slot (250b), and simultaneously the extended portion (210d) gets received in the second cutout (250c). The receiving of the locking element (230) inside the slot (250b) locks the connector (200) with the reflector panel (250).

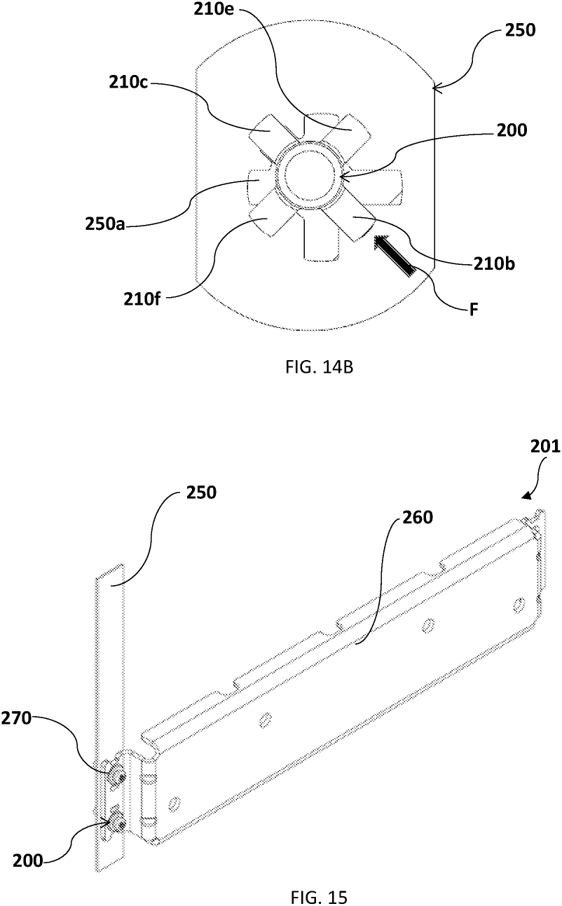

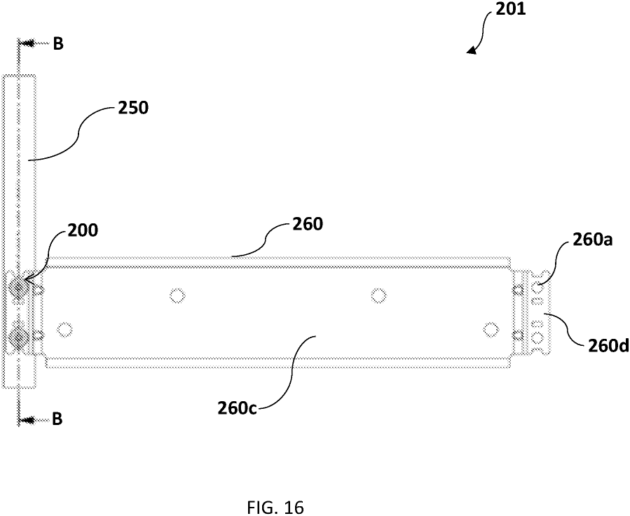

Referring to FIGS. 15-18, multiple views of a reflector assembly (201) is depicted. The reflector assembly (201) comprises the reflector panel (250), the bracket (260) and the connector (200) positioned between the reflector panel (250) and the bracket (260), as shown in FIG. 15 and FIG. 16. The connector (200), as depicted in FIGS. 10-13, is employed for connecting the reflector panel (250) to the bracket (260), in accordance with an exemplary embodiment of the present disclosure.

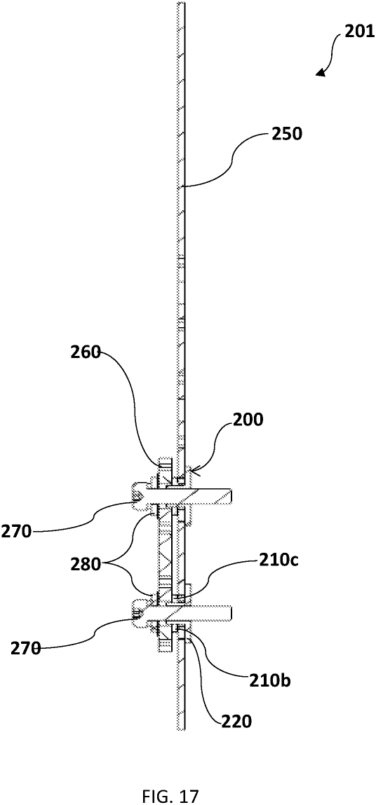

Referring to FIG. 16, the bracket (260) comprises a panel (260c) having two legs (260d) longitudinally extending from the panel (260c). The bracket (260) comprising the leg (260d) is having the hole (260a) for receiving the fastener (270). A cross-sectional view along line B-B of the reflector assembly (201) is depicted in FIG. 17, in accordance with an exemplary embodiment of the present disclosure. In a method for connecting the reflector panel (250) to the bracket (260) through the connector (200), a first step comprises locking the connector (200) to the reflector panel (250). Once the connector (200) is locked to the reflector panel (250), a step of placing the bracket (260) onto the connector (200) is employed, such that the hole (260a) on the bracket (260) receives the cylindrical structure of the gripping element (210) and the bracket (260) rests on the at least two arms (210b, 210c) of the gripping element (210). The method further comprises passing the fastener (270) through the threaded hole (210a) in the gripping element (210). In a further step, the fastener (270) is rotated to facilitate tightening of the fastener (270) along the threaded hole (210a) of the connector (200). The second arm (210c) of the at least two arms (210b, 210c) comprising the extended portion (210d) is configured to absorb torque exerted on the connector (200) during tightening of the fastener (270). The extended portion (210d) abuts against side walls of the second cutout (250c) in the reflector panel (250), in order to absorb torque on the connector (200).

In an embodiment of the present disclosure, the connector is defined having a unitary structure and reduces the inventory required for connecting the reflector panel on to the bracket.

In an embodiment of the present disclosure, the connector is configured to absorb torque exerted on the connector during tightening of the fastener.

In an embodiment of the present disclosure, the connector comprises gripping element configured to absorb the torque and which in turn increases life time of the connector.

In an embodiment of the present disclosure, the connector reduces an overall cost including the manufacturing cost, assembling cost and maintenance cost.

In another embodiment of the present disclosure, the unitary structure of the connector reduces the assembling time for connecting the reflector panel to the bracket.

In another embodiment of the present disclosure, the connector comprises integrally formed gripping element to electrically isolate the metal-to-metal joint between the reflector panel and the bracket.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature’s relationship to another element(s) or feature(s) as illustrated in the FIGS. It will be understood that the spatially relative terms are intended to encompass different orientations of the device in use or operation in addition to the orientation depicted in the FIGS. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

We claim:

1. A connector for connecting a reflector panel to a bracket, the connector comprising:
a gripping element extending from an upper surface of a base plate of the connector, wherein the gripping element is configured to provide isolation between the reflector panel and the bracket,
the gripping element has a threaded hole adapted to receive a fastener for connecting the reflector panel with the bracket through the connector; and
at least one locking element to facilitate locking of the connector with the reflector panel.

2. The connector as claimed in claim 1, wherein the gripping element and the at least one locking element are integrally formed on the base plate of the connector.

3. The connector as claimed in claim 1, wherein the upper surface of the base plate abuts against the reflector panel.

4. A connector for connecting a reflector panel to a bracket, the connector comprising:
a base plate having an upper surface;
a gripping element extending from the upper surface of the base plate, wherein the gripping element is having a threaded hole;
an at least one guide pin extending from the upper surface of the base plate; and
at least two locking elements extending from the upper surface of the base plate to facilitate locking of the connector with the reflector panel.

5. The connector as claimed in claim 4, wherein the gripping element is defined having a cuboidal shaped structure, configured to provide isolation between the reflector panel and the bracket.

6. The connector as claimed in claim 4, wherein the at least one guide pin is adapted to be inserted in an at least one hole formed in the reflector panel and in an at least one aperture formed in the bracket.

7. The connector as claimed in claim 4, wherein the gripping element is adapted to be inserted in a cutout formed in the reflector panel.

8. The connector as claimed in claim 4, wherein the at least two locking elements are snap-fit elements adapted to be received in at least two slots formed in the reflector panel.

9. The connector as claimed in claim 4, wherein the gripping element, the at least one guide pin and the at least two locking elements are integrally formed on the base plate of the connector.

10. A connector for connecting a reflector panel to a bracket, the connector comprising:
a gripping element formed with a base plate of the connector, wherein the gripping element comprises a threaded hole adapted to receive a fastener for connecting the reflector panel with the bracket through the connector,
at least two arms laterally extending from an outer surface of the gripping element, and said at least two arms are configured to provide isolation between the reflector panel and the bracket;
a locking element provided on a bottom surface of a first arm of the at least two arms, wherein the locking element is configured to lock the connector with the reflector panel;
a second arm positioned opposite to the first arm comprising an extended portion formed at junction of the second arm and the gripping element.

11. The connector as claimed in claim 10, wherein the gripping element is defined having a cylindrical shaped structure with the at least two arms laterally extending from the outer surface of the gripping element.

12. The connector as claimed in claim 10, wherein the at least two arms are adapted to be received in respective cutouts formed on the reflector panel.

13. The connector as claimed in claim 10, wherein the locking element is adapted to be received in a slot formed on the reflector panel.

14. The connector as claimed in claim 10, wherein a length of the respective arm of the at least two arms formed on the gripping element are distinct from one another.
